(19) United States
(12) Patent Application Publication
(10) Pub. No.: US 2026/0344722 A1
(43) Pub. Date: Nov. 5, 2026

(54) PROCESS FOR PRODUCTION OF COLLOIDAL PARTICLES FROM BOTANICAL RAW MATERIAL

(71) Applicant: SYMRISE AG, Holzminden (DE)

(72) Inventors: Tobias TRAPP, Nörting (DE); Jenny WEISSBRODT, Holzminden (DE); Daniel BALKE, Höxter (DE)

(21) Appl. No.: 19/118,807

(22) PCT Filed: Oct. 20, 2023
(86) PCT No.: PCT/EP2023/079266

§ 371 Date: Apr. 7, 2025

(30) Foreign Application Priority Data
Oct. 21, 2022 (WO) PCT/EP2022/079430

(51) Int. Cl. A23L 27/00; A23F 3/22

(52) U.S. Cl. CPC A23L 27/80; A23F 3/22; A23L 27/72

(57) ABSTRACT

The present invention primarily relates to a process for resuspension of solid precipitated colloidal particles from a botanical raw material, preferably tea material, more preferably tea leaves, comprising: providing the solid precipitated colloidal particles from a botanical raw material, preferably tea material, more preferably tea leaves; resuspending the colloidal particles in water by means of alkaline treatment, optionally in combination with shearing; and obtaining a liquified suspension containing suspended colloidal particles derived from the botanical raw material, preferably tea material, more preferably tea leaves. The present invention further relates to related processes, uses and preparations.

### INTRODUCTION

The present invention primarily resides in the field of flavors, in particular flavor stabilization, more particularly flavor stabilization by means of colloidal particles derived from botanical raw material.

Tea beverages are some of the most consumed beverages world-wide. Tea beverages are typically obtained by infusing or extracting the dry leaves harvested from plant materials. They are typically consumed directly as hot infused (or “brewed”) beverages, in a bottled form as ready-to-drink (RTD) beverages (e.g. iced tea) or after re-solubilization of granulated instant tea powders.

Most commonly referred to as “true teas” are beverages produced from the tea shrub (Camellia sinensis), which is further processed into multiple, distinct tea types (e.g. black tea, green tea, oolong tea, white tea, yellow tea, dark tea). Post-harvest processing of the fresh leaves is depending on the respective tea type, and may include withering, drying, oxidation (“fermentation”), roasting and microbial post-fermentation (Shi et al., 2021. Updates on the chemistry, processing characteristics, and utilization of tea flavonoids in last two decades (2001-2021). Critical reviews in food science and nutrition, 1-28.).

Tea leaves have a complex composition of components of different functional groups. On a dry matter basis, the most prevalent compounds in fresh tea leaves are on dry weight basis: phenolic compounds (30%), crude fiber (26%), protein (15%), lipids (7%), other carbohydrates (7%), minerals (5%), amino acids (4%), and caffeine (4%). The major difference between fresh tea leaves and fermented black tea leaves is the composition of phenolic compounds. Non-oxidized polyphenols such as flavanols dominate in fresh leaves, whereas oxidized and condensed polyphenols such as theaflavins and thearubigins are more prevalent in fermented leaves. The composition of brewed tea beverages changes significantly, as only traces of lipids, and proteins, are extracted during the aqueous brewing process (Belitz, H. D., Grosch, W., & Schieberle, P., (2009). Coffee, tea, cocoa. In: Belitz, H. D., Grosch, W., Schieberle, P. Eds. Food Chemistry. 4th Ed., Leipzig: Springer, pp. 938-970).

Another botanical species prevalently used for producing tea beverages is yerba mate or mate (Ilex paraguariensis), which is native to Southern American countries. Before being consumed, the leaves are typically blanched, dried and aged. The processed leaves are then used to brew different varieties of yerba mate beverages. Mate leaves contain on average significant amounts of the following components: protein (12%), polyphenols (7.4%), minerals (6%) and methylxanthines, whereof mainly caffeine (0.5% to 1.5%) (Belitz et al., 2009). Several health benefits have been demonstrated for yerba mate, including high antioxidative effects (Heck, C I, and E G de Mejia. “Yerba Mate Tea (Ilex paraguariensis): a comprehensive review on chemistry, health implications, and technological considerations.” Journal of food science vol. 72, 9 (2007)). The emulsifying capacity of yerba mate and extracts made thereof have not been revealed yet.

Tea extracts are typically produced by aqueous solvent extraction of dried tea leafs. Typically, the pH of the medium is adjusted prior to extraction, using either brines (e.g. NaOH, KOH) or acids (e.g. citric acid). Tea extraction under acidic conditions (pH 2-3) is described in U.S. Pat. Nos. 4,539,216 A and 4,668,525 A. Tea extraction under alkaline conditions (pH>7, preferably pH 8-10) is described in U.S. Pat. No. 3,821,440 A. In particular for black teas, alkaline conditions are applied to increase the extraction yield. Extraction is performed under heating, typically at boiling conditions around 100 °C, but may also be performed at up to 170 °C (U.S. Pat. Nos. 4,539,216 A, 4,668,525 A). The processing is optimized with respect to the extraction of the water-soluble tea components. After removal of the spent tea leaves, the aqueous extract is concentrated to a desired solid content (e.g. 20-25%) in order to obtain a pasty tea extract. Further processing involves aroma stripping and de-creaming steps. The pasty tea extract is often further dried into a powder form, e.g. by means of spray-drying, vacuum-drying or freeze-drying. The major food application of tea extracts, either in pasty or dried powder form, is for the production of ready-to-drink (RTD) bottled teas, e.g., iced teas, or instant tea powders.

In the production of tea extract, three main fractions are generated, which are separated e.g., by centrifugation and filtration techniques: 1. Spent tea leaves; 2. Tea cream (solid precipitate); and 3. Tea infusion (liquid). Liquid tea infusion, which comprises of extracted soluble tea components, is further processed (e.g., concentrated, dried) to produce the target tea extract (e.g., as a paste or powder).

In order to convert liquid flavorings into a solid, powdered form, microencapsulation by means of spray-drying is applied in many cases. The spray-drying process typically results in spherical microcapsules with a porous coating or matrix as a carrier. The flavor-active compounds are thus either entrapped in the core of the coating or adsorbed on the matrix surface. Prior to spray-drying, an emulsion or a slurry of the flavoring is produced, for which additional emulsifiers may be required depending on the polarity of the flavoring. Against this background, often blends of carriers and emulsifiers are used. Two very common combinations are blends of modified starches/hydrolyzed starches or gum Arabic/hydrolyzed starches. Among the group of hydrolyzed starches, maltodextrins are used most commonly. These currently used blends are related to certain drawbacks: Gum Arabic is relatively costly and the supply is increasingly limited. Modified starches often impart off-flavors. In Europe, maltodextrin is typically derived from wheat, whereas corn is the major source in the United States. Maltodextrins are regarded increasingly critically by consumers and their allergenic potential has to be labeled in some countries according to the source material. Oxidation processes during storage generate non-desirable off-flavors, which limit the shelf-life of the spray-dried flavoring powders. Citrus flavorings (e.g., citrus oils) are particularly susceptible to these chemical reactions. Exemplary reactions are oxidations of limonene with a typical citrus-like odor towards non-desirable derivatives such as carvone and carveol or towards various hydroperoxides. To limit the oxidative deterioration, antioxidants (e.g., tocopherol) are added to spray-drying formulas.

Previous work of the inventors, which is the subject of post-published patent application PCT/EP2022/060225A, demonstrates the excellent technofunctional properties of tea extracts, which may be applied for flavor encapsulation. The underlying process development and optimization was based on a combination of three main analytical findings:

Firstly, tea extracts (in particular black tea extracts) allowed the formation and stabilization of oil-in-water emulsions with small droplet sizes (<5 μm) and physical stability against phase separation for several months. This was explained by colloidal particles present in the tea extracts serving as Pickering emulsifying particles by adsorption to the oil/flavor droplet interface and thus prevent droplet coalescence. Secondly, the high content of soluble components present in the tea extracts allowed their application as carrier material for spray drying. Thirdly, the obtained flavor-encapsulating powders based on tea extracts exhibited significantly extended shelf-life stabilities compared to conventional emulsifier/carrier combinations (e.g. OSA-modified starch/maltodextrin). This indicated the high oxidative stability against chemical oxidation by tea extract encapsulation.

Based on the developed process, tea extracts may thus be applied as natural replacers for emulsifiers, carriers, and/or antioxidants that are currently/conventionally used in flavor encapsulation.

Because tea extract is a valuable substance, it would be desirable to have a cheaper source for substances with technofunctional properties.

### DESCRIPTION

The present invention seeks to solve the problem to provide a little-value source of substance(s) having technofunctional properties. A further aim was to provide a process for producing, enriching and/or refining said substance(s).

In a first aspect, the invention pertains to a process for resuspension of solid precipitated colloidal particles from a botanical raw material, preferably tea material, more preferably tea leaves, comprising: (a) providing the colloidal particles from the botanical raw material, preferably tea material, more preferably tea leaves; (b) resuspending the colloidal particles in water by means of alkaline treatment, optionally in combination with shearing; and (c) obtaining a liquified suspension containing the colloidal particles in suspended form.

The solid precipitated colloidal particles as understood herein include and/or consist of solid complexes consisting of (agglomerated) colloidal particles, which spontaneously assemble during extraction of botanical raw materials, preferably tea material, more preferably tea leaves. For the purpose of the present invention, they can be reversibly resuspended. When the colloidal particles stem from tea leaves, they can be formed as tea cream in the production of tea extracts. Tea cream is one of two side-streams produced during processing (the other side stream contains the spent tea leaves). The two side-streams may be removed together or separately. Tea cream is a well-known hazing and precipitation phenomenon, which occurs when strongly brewed tea infusions are cooled down. Its formation is initiated by the presence of spontaneously assembling colloidal tea particles (CTPs) with a complex heterogeneous composition of inter alia polyphenols, proteins, polysaccharides, and methylxanthines. CTPs were described as spherical particles with varying sizes (in the range of 50-500 nm). CTPs themselves normally do not affect turbidity due to their colloidal character. However, CTPs tend to aggregate to larger units depending on the process conditions, which eventually results in visible precipitation and hazing, the so-called tea cream (Jöbstl, E., Fairclough, J. P. A., Davies, A. P., & Williamson, M. P. (2005). Creaming in black tea. Journal of agricultural and food chemistry, 53, 7997-8002; Lin, X., Chen, Z., Zhang, Y., Luo, W., Tang, H., Deng, B., Deng, J., & Li, B. (2015). Comparative characterisation of green tea and black tea cream: physicochemical and phytochemical nature. Food chemistry, 173, 432-440; Lin, X., Gao, X., Chen, Z., Zhang, Y., Luo, W., Li, X., & Li, B. (2017). Spontaneously Assembled Nano-aggregates in Clear Green Tea Infusions from Camellia ptilophylla and Camellia sinensis. Journal of agricultural and food chemistry, 65, 3757-3766; Guo, C., Chen, Y., Li, J., Zhan, F., Wei, X., & Li, B. (2021). Role of green tea nanoparticles in process of tea cream formation-A new perspective. Food chemistry, 339, 128112).

Thus far, tea cream itself was considered non-desirable in the final product applications, as it may result in haze and sedimentation in beverages. Therefore, elaborate separation techniques such as centrifugation and filtration have been and still are typically applied for decreaming in order to avoid non-desirable turbidity and precipitation in the final tea products (Subramanian, R., Kumar, C. S., & Sharma, P. (2014). Membrane clarification of tea extracts. Critical reviews in food science and nutrition, 54, 1151-1157; Dubey, K. K., Janve, M., Ray, A., & Singhal, R. S. (2020). Ready-to-Drink Tea. In C. M. Galanakis (Ed.), Trends in non-alcoholic beverages (pp. 101-140). London, San Diego, CA, Cambride, MA, Kidlington: Academic Press). Another strategy to cope with the haziness due to tea cream is to run the process such that tea cream formation is minimized.

In contrast, the process of the invention is based on the inventors' innovation that the colloidal particles, e.g., contained in or forming the undesired tea cream, provide a cheap and valuable source for substances with techno-functional properties. Thus, the present invention disclosed herein intends either to actively form colloidal particles from botanical raw material, preferably tea material, more preferably tea leaves, or to valorize colloidal particles, for instance as a potential new emulsifying component for the flavor industry. Other techno-functional properties include, without limitation, capability to act as carrier material, as encapsulation material and as antioxidant.

In particular, the invention provides particles suitable for the production of Pickering emulsions, that is solid-stabilized emulsions. They do not require an emulsifier. The particles act as an emulsifier. To fulfil this function, the particle size should be less than one tenth of the desired oil droplet size of the emulsion.

The botanical raw material preferably includes or consists of tea leaves from varieties of Camellia sinensis or Ilex paraguariensis.

In a preferred embodiment, the colloidal particles contain polyphenols, preferably oxidized polyphenols, and, optionally, compounds from one, two or three compound classes selected from the group consisting of proteins, polysaccharides, and methylxanthines. It is also preferred that the liquefied suspension contains polyphenols, preferably oxidized polyphenols, and, optionally, compounds from one, two or three compound classes selected from the group consisting of proteins, polysaccharides, and methylxanthines. The functional groups of said compounds are associated with certain techno-functional properties that render them particularly suitable for emulsification or encapsulation of flavorings. Polyphenols can be attributed to an antioxidant activity. Non-oxidized polyphenols such as flavanols that dominate in fresh leaves have been well described regarding their antioxidative properties. Besides, scientific studies also demonstrated the antioxidative potential of oxidized or polymerized polyphenols, such as theaflavins, which are formed during fermentation and are thus more prevalent in black teas (Lai Kwok Leung; Yalun Su; Ruoyun Chen; Zesheng Zhang; Yu Huang; Zhen-Yu Chen (2001): Theaflavins in Black Tea and Catechins in Green Tea Are Equally Effective Antioxidants. In: The Journal of Nutrition 131 (9), S. 2248-2251). Caffeine belongs to the class of methylxanthines and is preferably contained in the colloidal particles and/or in the liquefied suspension. Caffeine has also antioxidative properties.

Herein, statements that particular substances are “contained in” the colloidal particles also embrace the possibility that the particular substances are present in admixture with the colloidal particles. Accordingly, the term “colloidal particles” does not necessarily refer to the colloidal particles themselves, but the desired product may also denote a mixture, in particular a dispersion, containing the colloidal particles. The skilled reader will readily understand that it primarily depends on whether the colloidal particles form, or are included in, the starting material or the product, which statements may be applicable to a, e.g., liquid, mixture containing the colloidal particles or to the colloidal particles as such, or to both.

In a further embodiment, the colloidal particles are resuspended at a pH value of at least pH 2 to 12, preferably at least pH 6 to 11.5, more preferably at least pH 7 to 11, most preferably at least pH 8 and/or pH 12 or less, preferably pH 11.5 or less, more preferably pH 11 or less, most preferably pH 10 or less. Each lower pH limit is to be understood to be combinable with each upper pH limit. These conditions were found to facilitate efficient resupension of the colloidal particles, in particular when tea material, preferably tea leaves are the source thereof. The pH conditions may be combined with shearing to enhance the resuspension step. Due to strong shear thinning behavior the viscosity of the colloidal particles, e.g., when provided in the form of tea cream, plummets with increasing shear rate and thus becomes more processible. The resuspension is done at shear rates of at least 200 s⁻¹, more preferably at least 1000 s⁻¹, most preferably at least 2000 s⁻¹.

Preferably, the alkaline treatment, whether conducted alone or in conjunction with the shearing, includes direct titration with an alkali base, preferably sodium hydroxide. The alkali base, preferably sodium hydroxide, was found to outperform a (citrate) buffer having an equal pH value.

The suspended colloidal particles obtained by the process of the invention may have number average particle sizes of 500 nm or lower, preferably 400 nm or lower, more preferably 300 nm or lower, most preferably 200 nm or lower, and/or at least 25 nm, preferably at least 50 nm, more preferably at least 75 nm, most preferably at least 100 nm.

The suspended colloidal particles obtained by the process of the invention preferably have a volume median particle size of 1000 nm or lower, preferably 500 nm or lower, more preferably 200 nm or lower, most preferably 150 nm or lower, and/or at least 25 nm, preferably at least 50 nm, more preferably at least 75 nm, most preferably at least 100 nm.

When the particle size is lower than 200 nm, formation of haziness can be prevented over a substantial amount of time.

According to a second aspect of the invention, a process for producing (technofunctional) colloidal particles from a botanical raw material, preferably tea material, more preferably tea leaves, comprises the following steps: (I) conducting alkaline extraction of the botanical raw material, preferably tea material, more preferably tea leaves, to form an extract; (II) conducting acidic creaming precipitation of the extract to form colloidal particles; and (III) concentrating the colloidal particles. Preferably, the concentrating involves separating the precipitated colloidal particles from supernatant by mechanical and/or thermal separation.

The process for producing (technofunctional) colloidal particles from a botanical raw material according to the second aspect of the invention can also be described to comprise the steps of: (l′) conducting alkaline extraction of the botanical raw material, preferably tea material, more preferably tea leaves, to form an extract; (II′) conducting acidic creaming precipitation of the extract to form a precipitate and a supernatant; and (III′) separating the precipitate from the supernatant to provide the colloidal particles in the form of the precipitate. Preferably, the separating involves separating the precipitated colloidal particles from supernatant by mechanical and/or thermal separation. The second aspect of the invention exploits the finding of the inventors that the alkaline extraction of soluble compounds from the botanical raw material, preferably tea material, more preferably tea leaves, in combination with the acidic creaming precipitation results in a high yield of the precipitated colloidal particles. The term “botanical raw material” as used herein denotes a raw material obtained from a plant, and includes leaves, flowers, fruits, roots, stems and seeds. The term “tea material” refers to a botanical raw material obtained from a tea plant. The botanical raw material preferably includes or consists of tea leaves from varieties of Camellia sinensis or Ilex paraguariensis.

In a preferred embodiment, step (I) conducting alkaline extraction of the botanical raw material, preferably tea material, more preferably tea leaves, to form the extract includes (I-a) providing the botanical raw material, preferably tea material, more preferably tea leaves; (I-b) adding water to the botanical raw material, preferably tea material, more preferably tea leaves, and adjusting the pH value to more than pH 7, preferably pH 8 or more, more preferably pH 9 or more and/or pH 12 or less, preferably pH 11.5 or less, most preferably pH 11 or less; (I-c) incubating the pH-adjusted mixture of the water and the botanical raw material, preferably tea material, more preferably tea leaves, optionally while maintaining the mixture at a temperature above ambient temperature; and (I-d) after the incubation, separating liquid from solid to provide the extract. Each lower pH limit is to be understood to be combinable with each upper pH limit.

In a further preferred embodiment, step (II) conducting acidic creaming precipitation of the extract to form the precipitate and the supernatant includes: (II-a) adjusting the pH value of the extract to less than pH 7, preferably less than pH 6, more preferably less than pH 5, most preferably less than pH 4, and/or pH 2 or more, preferably pH 2.5 or more; and (II-b) incubating the pH-adjusted extract under conditions suitable for precipitation, preferably at a temperature lower than the incubation temperature in step (I-c), more preferably at sub-ambient temperature, to form the precipitate and the supernatant. Each lower pH limit is to be understood to be combinable with each upper pH limit.

The conditions of the alkaline extraction step include preferably one or more of the following:

The water may be added in a weight excess relative to the weight of the botanical raw material, preferably the weight ratio of the botanical raw material to the water ranges from more than 1:1 to 1:50, more preferably from 1:2 to 1:40, yet more preferably from 1:4 to 1:30, most preferably from 1:6 to 1:20.

The pH-adjusted mixture of the water and the botanical raw material may be incubated above 50 °C, preferably above 70 °C, more preferably above 80 °C, most preferably above 90 °C and/or at or below 175 °C, preferably at or below 150 °C, more preferably at or below 125 °C, most preferably at or below 100 °C (each lower temperature limit is to be understood to be combinable with each upper temperature limit).

The pH-adjusted mixture of the water and the botanical raw material may be incubated for at least 30 minutes, preferably at least 60 minutes, more preferably for at least 75 minutes, most preferably for at least 90 minutes.

The temperature of the incubated mixture of the water and the botanical raw material, when subjected to the separation, may be at least 30 °C, preferably at least 50 °C, more preferably at least 70 °C, most preferably at least 80 °C and/or at or below 150 °C, preferably at or below 140 °C, more preferably at or below 130 °C, most preferably at or below 120 °C. In particular preferred embodiments, the temperature is around (e.g., +20 °C, +10 °C, or +5 °C) 100 °C. Each lower temperature limit shall be understood to be combinable with each upper temperature limit.

The conditions at which the acidic creaming precipitation step (II) is conducted preferably include one or more of the following:

The pH-adjusted extract may be incubated at sub-ambient temperature, preferably 20 °C or less, more preferably 15 °C or less, most preferably 10 °C or less, and/or at least 0 °C, preferably at least 1 °C, more preferably at least 2 °C, most preferably at least 3 °C. Each lower temperature limit shall be understood to be combinable with each upper temperature limit.

The incubation temperature may be maintained for at least 6 hours, preferably at least 8 hours, more preferably at least 12 hours, most preferably at least 1 day, and/or at most 7 days, preferably at most 5 days, more preferably at most 4 days, most preferably at least 3 days. Each lower time limit shall again be understood to be combinable with each upper time limit.

The colloidal particles/precipitate may be separated from the supernatant with any suitable solid-liquid separation technique. Preferred in this context are filtration, centrifugation, decanting and/or evaporation.

In a third aspect of the present invention, the process of the second aspect is combined with the process of the first aspect, to produce a liquefied suspension containing suspended colloidal particles (as described herein) from a botanical raw material, preferably tea material, more preferably tea leaves. That is, the process of the second aspect of the invention (including its embodiments) further comprises conducting the process of the first aspect of the invention (and its embodiments) using the colloidal particles/precipitate produced by the process of the second aspect as starting material. Put another way, the botanical raw material, preferably tea material, more preferably tea leaves, is first processed in accordance with the process of the second aspect of the invention to form the colloidal particles/precipitate, i.e. the precipitated colloidal particles, e.g. in the form of tea cream. Then, the colloidal particles/precipitate is processed according to the process of the first aspect of the invention to produce the liquefied suspension containing the suspended colloidal particles. Whenever reference is made herein to an aspect (of the invention), this includes also its embodiments as exemplarily indicated immediately above by the wording in parentheses.

A fourth aspect of the present invention pertains to a process for producing a dispersion with techno-functional properties comprising the following steps:
(i) Providing a liquefied suspension containing suspended colloidal particles from a botanical raw material, preferably tea material, more preferably tea leaves, and water. The liquefied suspension is preferably produced or producible by the process of the first aspect (i.e., starting from precipitated colloidal particles, e.g. in the form of tea cream), or by the process of the third aspect (i.e., starting from botanical raw material, preferably tea material, more preferably tea leaves).
(ii) Adding a functional agent, preferably a flavoring, to the suspension.
(iii) Preparing an emulsion, containing the functional agent.
(iv) Optionally, drying the emulsion, preferably by spray-drying.
(v) Providing the dispersion with technofunctional properties in the form of the emulsion or the dried emulsion.

According to IUPAC, the term “dispersion” denotes material comprising more than one phase where at least one of the phases consists of finely divided phase domains, often in the colloidal size range, dispersed throughout a continuous phase. This definition shall apply herein. Accordingly, an emulsion can be described as being characterized by finely divided liquid phase domains within another liquid phase. The term “dispersion” also encompasses a mixture of solid phase domains within a liquid phase (often described as a “slurry”). More specifically, the term “slurry” as understood herein defines a mixture of generally small solid particles (e.g. having a mean diameter ranging from 0.01 μm to 1000 μm, preferably 0.02 to 100 μm) denser than the liquid phase dispersed or at least suspended in the liquid phase, i.e. water.

A functional agent, as understood herein, is preferably a flavoring, in particular a flavoring conveying a fruity or spicy note. In one embodiment, the flavoring conveys a taste or smell of lemon lime, cola, peach and/or grapefruit. In this embodiment, it is further preferred that the dispersion is used for producing a preparation for nourishment or pleasure, particularly a beverage (as described herein elsewhere).

In another embodiment, the flavoring conveying a spicy note is one that conveys a taste or smell being described as umami, kokumi and/or salty. The umami taste impression is frequently described by the terms “broth-like,” “meaty,” “mouth-filling,” and “spicy,” and is often seen in connection with the taste impression of kokumi. In addition, the umami taste impression often contributes to saltiness as part of the overall taste perception, although saltiness is particularly caused by sodium ions, especially in the form of sodium chloride. An umami taste impression is a typical characteristic of savory foods. In this embodiment, it is further preferred that the dispersion is used for producing a convenience food, such as a soup, a sauce or a snack (as described herein elsewhere).

In all embodiments, the flavoring is preferably liquid, e.g., at least between 15 °C and 25 °C. The term “flavoring” is used herein to denote a compound or mixture of compounds, which, in aroma-active quantities, imparts a perceptible taste and/or odor. In this context, the term “aroma-active” refers to the amount of the compound in a preparation that is sufficient to elicit a sensory effect at odor and/or taste receptors. Such an effect may also manifest itself by reducing or masking an unpleasant taste- and/or odor-based sensory perception. Of particular interest to the present invention are taste and/or odor impressions that are perceived as pleasant. The assessment of whether a taste and/or odor impression is considered pleasant or rather unpleasant can be made by a sensory analysis by a trained panel based on an evaluation of the sensory impression between negative (pleasant) and positive (unpleasant). Additional levels such as very negative, neutral, and very positive can be provided for more precise classification. The determination of the notes of a flavoring to be evaluated, which may be present in a mixture along with further compounds, possibly further flavorings, can be carried out, for example, by means of gas chromatography-olfactometry.

The fourth aspect of the present invention is based on the innovation of the inventors' that a functional agent such as a flavoring, substances contained in a botanical cream, preferably tea cream, and water form a stable dispersion, irrespective whether dried or not. In the process of the invention, the colloidal particles may assume one or more functions of encapsulating droplets of the functional agent (often oily/hardly soluble in water), stabilizing the droplets and stabilizing the water phase due to the antioxidative properties of substances contained in the botanical raw material, preferably tea material, more preferably tea leaves, and/or contained in the precipitated colloidal particles, e.g. in form of tea cream. A great advantage of the fourth aspect of the present invention is that the process makes use of a waste product and thus does not stand in competition with tea brewing industry. It thus provides a very economic process for the production of a dispersion that can be used in further processing to a preparation for nourishment or pleasure, such as beverages (as described further below). Notably, the advantages achieved by the present invention are not limited to beverages such as iced teas but can be generally exploited, wherever a flavoring-containing preparation (incl, flavoring-containing semi-finished products) needs to be stabilized until use.

In one embodiment of the present invention, the dispersion is an emulsion. That is, the functional agent forms an emulsion with the colloidal particles from the botanical raw material, preferably tea material, more preferably tea leaves, (serving as emulsifier among others) and the water. In practice, this means that the functional agent has a polarity (is rather nonpolar) so that it is not or not completely dissolved in water but forms a separate phase (herein also referred as oil phase) (e.g., at a temperature ranging from 10 to 40 °C, preferably 15 to 30 °C). Thus, mixing results in the formation of an emulsion that is facilitated and stabilized by the colloidal particles. Due to the presence of the colloidal particles, the formed emulsion is stable over at least 12 h, 1 d, 2 d, 3 d, 4 d, 5 d, 6 d, 7 d, 8 d, 9 d or at least 10 d. Stability in this context denotes that the emulsion maintains its structure substantially unchanged (e.g., regarding its droplet size distribution). For instance, the mean droplet size does not deviate by more than 50%, 40%, 30%, or 20% as compared to the initial mean droplet size measured directly after formation of the emulsion. It is noted that, if the emulsion is dried, the emulsion should be sufficiently stable as long as it is still liquid (has not been dried yet). Preferably, the stability is maintained for at least 24 h.

Notably, the colloidal particles from the botanical raw material, preferably tea material, more preferably tea leaves have powerful emulsifying properties such that there is no need to add any additional emulsifier. Thus, in the context of the present invention, it is preferred that the preparation or semi-finished product includes no further emulsifier than the colloidal particles from the botanical raw material, preferably tea material, more preferably tea leaves.

Optionally, the emulsion is then dried to evaporate water. The water evaporation during the drying, preferably spray-drying, of the emulsion results in a dried emulsion, preferably in the form of a powder. The powder may comprise or consist of solid microcapsules with mean diameters of 0.1 to 1000 μm, preferably 0.5 to 100 μm, more preferably 1 to 50 μm. The microcapsules may be described to have a spherical structure with a coating comprising of the carrier, in this case the colloidal particles, wherein the (non-polar) functional agent is embedded in the form of droplets in the core. Accordingly, the colloidal particles from the botanical raw material, preferably tea material, more preferably tea leaves, do therefore not only serve as an emulsifier but also as a carrier for microencapsulating the functional agent.

Due to the powerful emulsifying capabilities of the colloidal particles, it is not absolutely necessary to dry the emulsion, but the dispersion can be provided in the form of the emulsion itself, as described further above.

In addition, by means of simulated aging, the inventors observed that the emulsion obtained by the process of the invention is also stable in terms of degradation/oxidation processes, and even outperforms known emulsions based on OSA-modified starch as emulsifier. The responsibility for this chemical stability is again ascribed to (the functional groups contained in) the colloidal particles.

According to another embodiment, the functional agent is dissolved (dissolvable) in the water and forms with the colloidal particles a suspension or dispersion of solid phase domains in the water. Drying thereof yields the dispersion.

Subsequent water evaporation during drying of the slurry results in a dried dispersion, preferably in the form of a powder. The powder may comprise solid particles with mean diameters of 1 to 1000 μm. The particles may be described to have a spherical structure. The functional agent may be embedded, e.g., dispersed, in, and/or bound to, a matrix. The matrix may be formed by known carrier materials such as maltodextrin, whereas the main function of the colloidal particles is to act as an emulsifier. It may also be possible that the colloidal particles serve as a carrier material for the functional agent.

Small powder particle sizes are related to technical drawbacks such as blocking or health risks for the operator. Therefore, larger particle sizes are preferred. In embodiments leading to a dried emulsion, it is thus preferred that particles have a mean diameter of 50 nm to 2 mm, preferably 5 μm to 1 mm, more preferably 10 μm to 500 μm. To increase the particle size, powder agglomeration by means of multiple stage drying techniques such as fluidized bed agglomeration or spray-bed drying (SBD) can be conducted.

Such drawbacks do not exist in (liquid) emulsions. Therefore, in embodiments resulting in an emulsion, it is preferred that the emulsion contains droplets having a mean diameter of below 10 μm, more preferably below 5 μm, most preferably below 1 μm. The lower limit is generally determined by technical, physical and/or rheological limits. However, it is also envisaged that the droplet have a mean diameter of above 20 nm, preferably above 30 nm, more preferably above 40 nm, most preferably above 50 nm.

The shelf-life, or oxidative stability, of the dried dispersion (dried emulsion or dried slurry) is preferably at least 3, 4. 5, 6, or 9 months, more preferably at least 12 months, most preferably at least 18 months and/or up to 24 months. The shelf-life as understood herein indicates the time for which no negative and/or changed taste, odor and/or visual impressions can be perceived by trained panelists on a statistically significant level, when the powder is applied in a beverage formulation. A visual assessment in the context of the shelf-life is preferably based on changes in color and/or occurrence of turbidity and/or precipitates.

In embodiments where the botanical raw material is tea leaves or where the precipitated colloidal particles are provided in the form of, or stem from, a tea cream, the tea is preferably selected from the group consisting of black tea, white tea, green tea, mate tea and combinations thereof. Most preferred is black tea since it has surprisingly turned out that the colloidal particles from black tea provide a more powerful emulsifier than those from white tea cream or green tea cream.

In embodiments employing drying, the drying is preferably carried out by single or multiple stage spray drying. An inlet air temperature may range from 140 °C to 250 °C, preferably 160 °C to 220 °C, more preferably 170 °C to 210 °C. An outlet air temperature may range from 40 °C to 100 °C, preferably 50 °C to 90 °C, more preferably 60 °C to 80 °C. If spray-drying is carried out, it is preferred that, from a perspective of operability, the dispersion to be spray-dried has a viscosity ranging from 100 to 150 mPas (determined at 25 °C).

In embodiments involving emulsification, the emulsion is preferably prepared by dispersing, sonication and/or homogenization. Preferably a rotor-stator dispersing instrument, and/or a high-pressure homogenizer is used for emulsification. It is further preferred that the water and the (liquefied suspension of) colloidal particles are mixed first and that then the functional agent is added to the mixture. For example, the functional agent may be added dropwise from the top of a container in which the mixture is presented. In another example, the functional agent is continuously poured into the mixture of the water and the colloidal particles, for example from the bottom or the side of the container in which the mixture is presented. As is generally known to the skilled person, the feed rate may have an impact on the emulsification and should be adapted to the specific circumstances. The disperging time depends on the volume of the mixture to be emulsified. About 2 minutes is sufficient for a volume of 60 to 150 mL. About 6 minutes is sufficient for a volume of 500 to 1000 mL. These values may be extrapolated to larger volumes.

As already mentioned above, the dispersion may include a carrier substance that do not naturally occur in the botanical material, preferably tea material, more preferably tea leaves, i.e. an exogen carrier material. A specifically mentioned exogen carrier substance is maltodextrin, although in preferred embodiments no hydrolyzed starch such as maltodextrin is used. The carrier substance is added to the mixture of functional agent and the suspended colloidal particles before emulsification. Water may be optionally added as well.

The resuspended colloidal particles obtained from the process of the first aspect, or from the process of the third aspect, has preferably a dry mass of at least 5 wt.-%, preferably at least 10 wt.-% and/or 50 wt.-% or less, preferably 25 wt.-% or less, relative to the total weight of the suspension. Each lower dry mass limit is meant to be combinable with each upper dry mass limit. Further, the weight ratio of the functional agent to the (resuspended) colloidal particles may be at least 0.01, preferably at least 0.05, more preferably at least 0.1, most preferably at least 0.25, and/or 10 or less, preferably 5 or less, more preferably 4 or less, most preferably 3 or less (on a dry weight basis). Each lower weight ratio limit is meant to be combinable with each upper weight ratio limit.

The dispersion may be provided as a dry powder or in liquid, e.g., pasty, form. If it is provided as a dry powder, the weight ratio of the colloidal particles to the water present in the emulsion preferably ranges from 1:10 to 10:1, preferably 1:5 to 5:1, more preferably 1:2 to 2:1 (on a dry weight basis). If it is provided in liquid, e.g., pasty form, the weight ratio of the colloidal particles to the water present in the emulsion preferably ranges from 1:1 to 100:1, preferably 2:1 to 50:1, more preferably 5:1 to 20:1.

The mixture of the functional agent and the colloidal particles (and, if present, the water) may optionally include further additives such as other polar liquids such as ethanol or propylene glycol and/or other nonpolar liquids such as a vegetable oil. Likewise, further components can be added that may either aid in formation of a matrix or particles upon drying or contribute to a desired functionality (e.g. stability) of the dispersion, such as additional matrix substance like maltodextrin.

According to a fifth aspect of the present invention, precipitated colloidal particles, preferably in the form of a tea cream, (as described herein) are produced or producible by the process of the second aspect of the invention. Herein, the colloidal particles contain polyphenols, preferably oxidized polyphenols, and, optionally, compounds from one, two or three compound classes selected from the group consisting of proteins, polysaccharides, and methylxanthines, in particular caffeine.

A sixth aspect of the present invention relates to the use of precipitated colloidal particles, preferably in the form of a tea cream, (as described herein) for the production of a dispersion with technofunctional properties (as described herein), wherein the precipitated colloidal particles, preferably in the form of the tea cream, contains polyphenols, preferably oxidized polyphenols, and, optionally, compounds from one, two or three compound classes selected from the group consisting of proteins, polysaccharides, and methylxanthines.

A preferred use of the precipitated colloidal particles, preferably in the form of the tea cream, (as described herein) is its use as, or its use for forming, an antioxidant for a functional agent (as described herein), preferably flavoring, and/or an emulsifier (as described herein). Preferably, the precipitated colloidal particles, preferably in the form of the tea cream, (as described herein) is used in a preparation for nourishment or pleasure (as described herein).

In a seventh aspect of the invention, a liquefied suspension contains suspended colloidal particles (as described herein) from a botanical raw material, preferably tea material, more preferably tea leaves (as described herein), produced or producible by the process of the first or third aspect of the invention. Herein, the liquefied suspension contains polyphenols, preferably oxidized polyphenols, and, optionally, compounds from one, two or three compound classes selected from the group consisting of proteins, polysaccharides, and methylxanthines.

According to an eighth aspect of the present invention, a preparation contains polyphenols, preferably oxidized polyphenols, and, optionally, compounds from one, two or three compound classes selected from the group consisting of proteins, polysaccharides, and methylxanthines. Preferably, the preparation is produced or producible by the process of the fifth aspect of the invention, optionally in combination with further processing of the dispersion. It is further preferred that the preparation is one for nourishment or pleasure, preferably a beverage or a convenience food, such as a soup, a sauce or a snack, or a semi-finished product for the production of a preparation for nourishment or pleasure, preferably a beverage or a convenience food, such as a soup, a sauce or a snack. In some embodiments, the preparation is free of solid (or solidifiable) material and/or exogen carrier material, preferably hydrolyzed starches. Moreover, it is preferred that the preparation or semi-finished product is free of an emulsifier not present in the colloidal particles or in the botanical raw material. For example, it is particular preferred that the preparation is free of modified starches and gum Arabic. Furthermore, it is preferred that the preparation is free of an antioxidant not present in the colloidal particles or in the botanical raw material. For example, it is particular preferred that the preparation is free of tocopherol.

In general, embodiments and features described herein in relation to a particular aspect of the invention define corresponding embodiments and features of all other aspects of the invention, unless the resulting combination is technically meaningless.

Further aspects and embodiments of the present invention will arise from the experiments, which follows after the brief description of the drawings.

The drawings show:

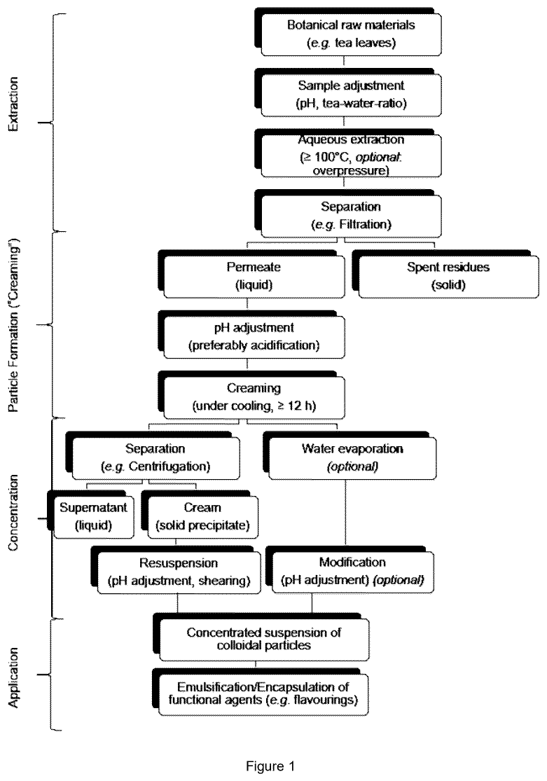

FIG. 1 Overall process flow scheme for the production and application of resuspended colloidal particles derived from botanical raw material.

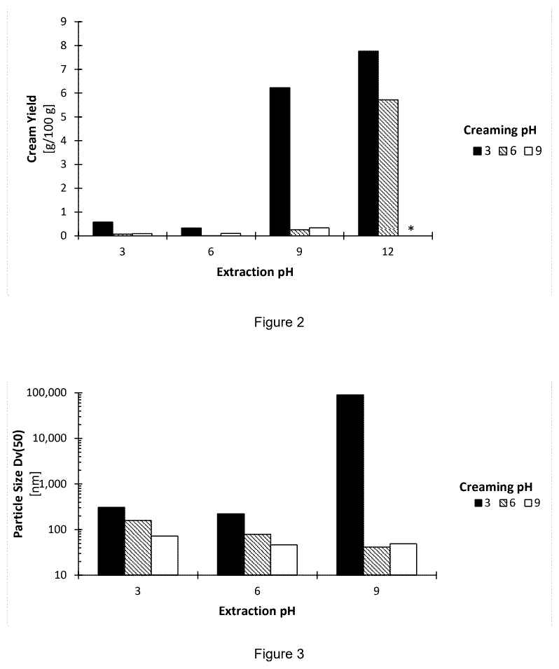

FIG. 2 Cream yields (on dry weight basis) measured after aqueous extraction of black tea leaves under variation of extraction pH and creaming pH. Otherwise standard conditions applied. *Cream yield could not be determined due to unclear phase separation.

FIG. 3 Medians Dv(50) of CTPs in supernatants after aqueous extraction of black tea leaves under variation of extraction pH and creaming pH (with otherwise standard conditions). Measured by means of Malvern 3000. Dv(50) in logarithmic scale.

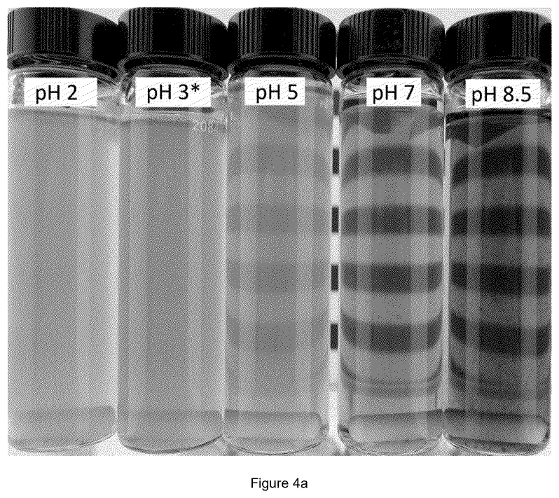

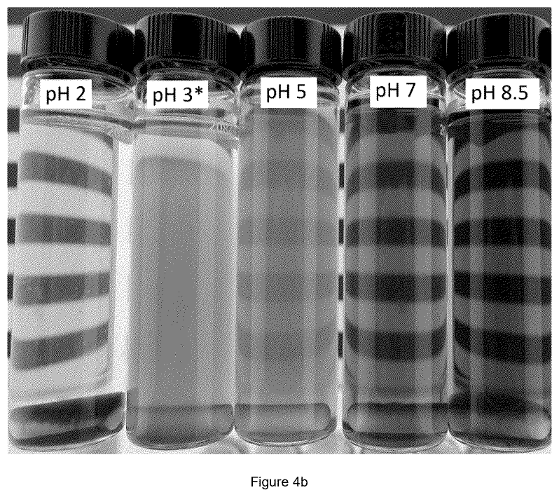

FIG. 4 Stability of black tea cream resuspended in phosphate-citrate-buffers (Mcllvaine, 1921). Comparison of suspensions (1 g cream per 100 g of buffer) directly after stirring (above) and after 24 h sedimentation time (below). Tea cream obtained after extraction (at pH 10 and 100 °C) and precipitation (at pH 3 and 4 °C). *pH3: cream dissolved in deionized water, pH 3 measured, but not adjusted separately.

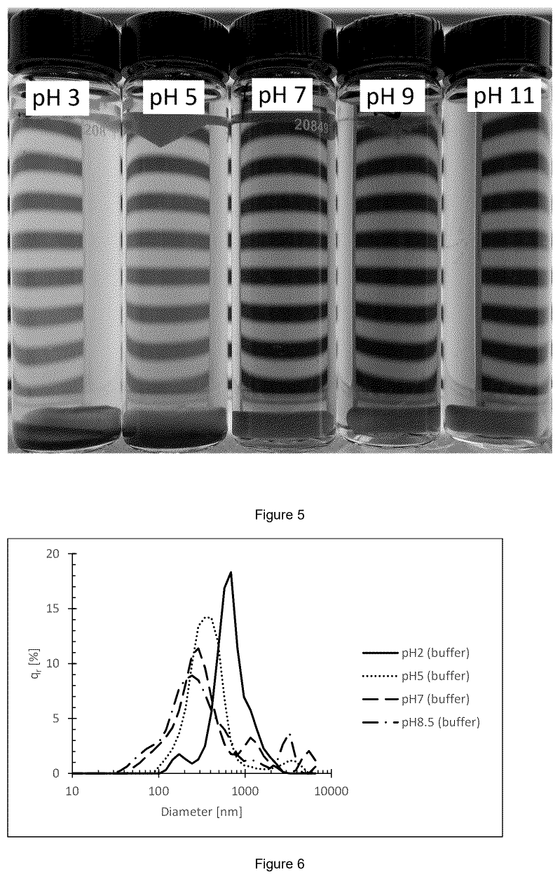

FIG. 5 Stability of tea cream resuspended in deionized water upon titration with NaOH. Comparison of suspensions (1 g cream per 100 g of water) after 2 d sedimentation time. Tea cream obtained after extraction (at pH10 and 100 °C) and precipitation (at pH3 and 4 °C).

FIG. 6 Particle size distributions of colloidal particles from black tea cream resuspended in phosphate-citrate-buffers (Mcllvaine, 1921). Tea cream obtained after extraction (at pH 10 and 100 °C) and precipitation (at pH 3 and 4 °C). Suspensions measured at concentration of 1 g cream per 100 g of buffer by means of dynamic light scattering.

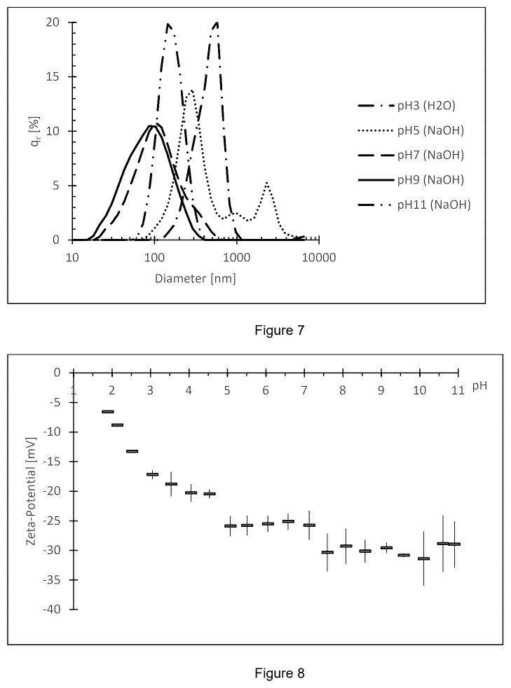

FIG. 7 Particle size distributions of colloidal particles from black tea cream resuspended in deionized water upon titration with NaOH. Tea cream obtained after extraction (at pH 10 and 100 °C) and precipitation (at pH 3 and 4 °C). Suspensions measured at concentration of 1 g cream per 100 g of deionized water by means of dynamic light scattering.

FIG. 8 Zeta-potential (as a function of pH) of colloidal particles from resuspended black tea cream. Tea cream obtained after extraction (at pH 10 and 100 °C), precipitation (at pH 3 and 4 °C), and resuspension by NaOH titration (until pH 11). Error bars indicate measured standard deviations.

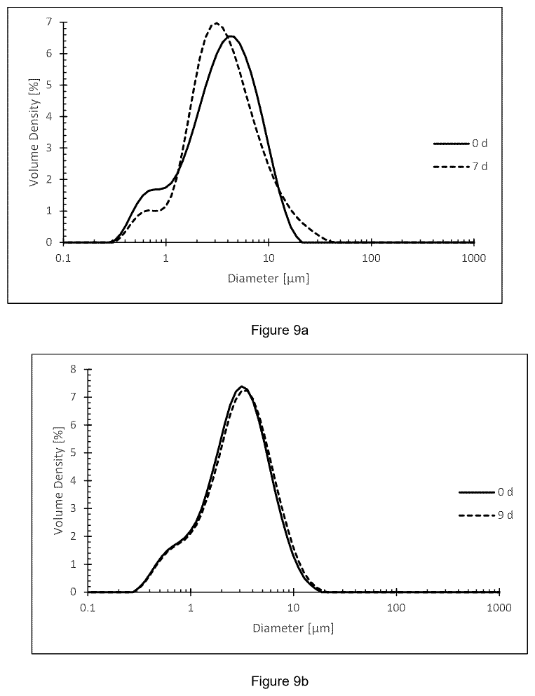

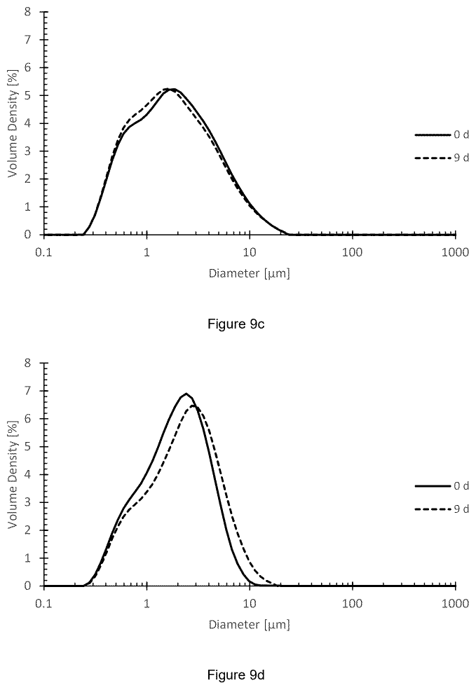

FIG. 9 Oil droplet stability of plant oil emulsions stabilized by colloidal particles obtained from black tea cream. Comparison of emulsion formulations: (A) BTE(3-3-8.5)-PO-E; (B) BTE(10-3-9)-PO-E-1; (C) BTE(10-3-9)-PO/EG-E; (D) BTE(10-3-9)/M-PO-E. Oil droplet size distributions measured after 0 d and 7 d/9 d at room temperature with Malvern 3000.

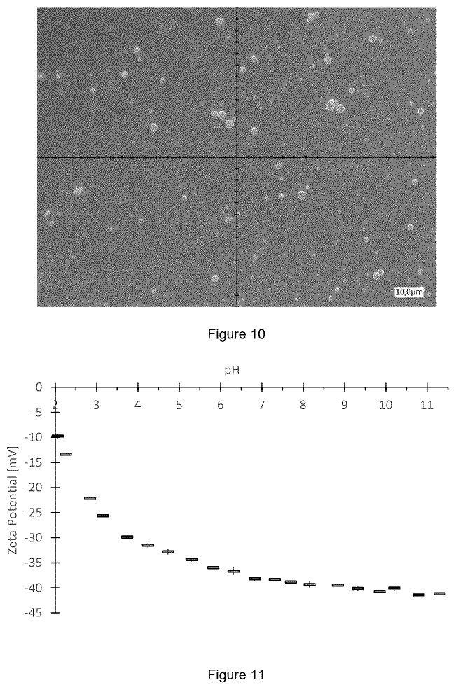

FIG. 10 Microscopic image of plant oil emulsion stabilized colloidal particles obtained from black tea cream. Emulsion formulation: BTE(3-3-8.5)-PO-E.

FIG. 11 Zeta-potential (as a function of pH) of plant oil emulsion stabilized colloidal particles obtained from black tea cream. Emulsion formulation: BTE(3-3-8.5)-PO-E. Error bars indicate measured standard deviations.

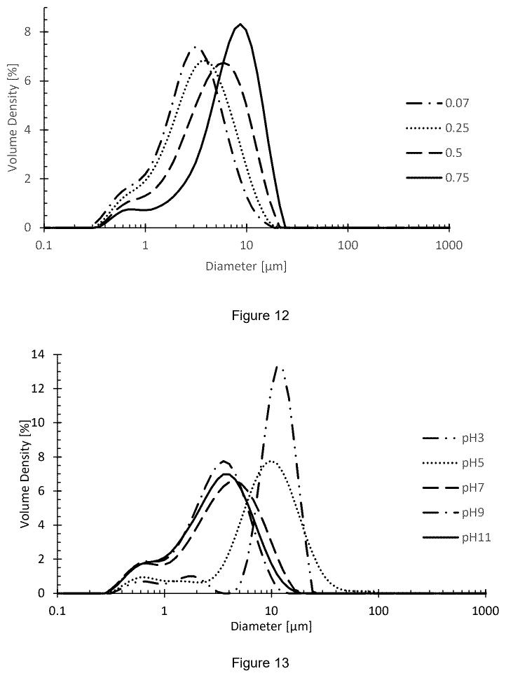

FIG. 12 Emulsification of plant oil by black tea cream under variation of oil-cream-ratio: Comparison of oil droplet size distributions measured by Malvern 3000. Tea cream obtained: extraction pH10, creaming pH3, and resuspension by NaOH titration until pH9. Formulations in ascending order: BTE(10-3-9)-PO-E-1; BTE(10-3-9)-PO-E-2; BTE(10-3-9)-PO-E-3; BTE(10-3-9)-PO-E-4 (see Table 1).

FIG. 13 Emulsification of D-limonene by tea cream under variation of resuspension pH: Comparison of oil droplet size distributions measured by Malvern 3000. Tea cream obtained: extraction pH10, and creaming pH3. pH adjusted during resuspension by NaOH titration. Oil-cream-ratio: 0.25. Formulations in ascending order: BTE(10-3-3)-L-E; BTE(10-3-5)-L-E; BTE(10-3-7)-L-E; BTE(10-3-9)-L-E; BTE(10-3-11)-L-E (see Table 1).

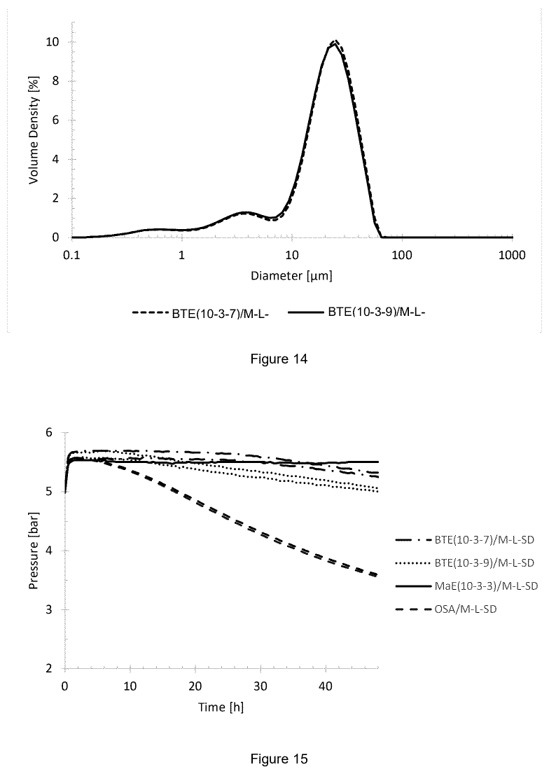

FIG. 14 Encapsulation of D-limonene by means of spray drying using resuspended black tea cream and maltodextrin as emulsifier/carrier system under variation of resuspension pH of tea cream. Comparison of powder particle size distributions measured using Malvern 2000.

FIG. 15 Pressure curves during simulated ageing of D-limonene encapsulated by different emulsifier/carrier systems: Comparison of tea cream/maltodextrin vs. OSA-modified starch/maltodextrin (=reference formulation). Measured pressure curves in Oxipres™ bombs during simulated shelf life of 12 months. Combinations measured in duplicate.

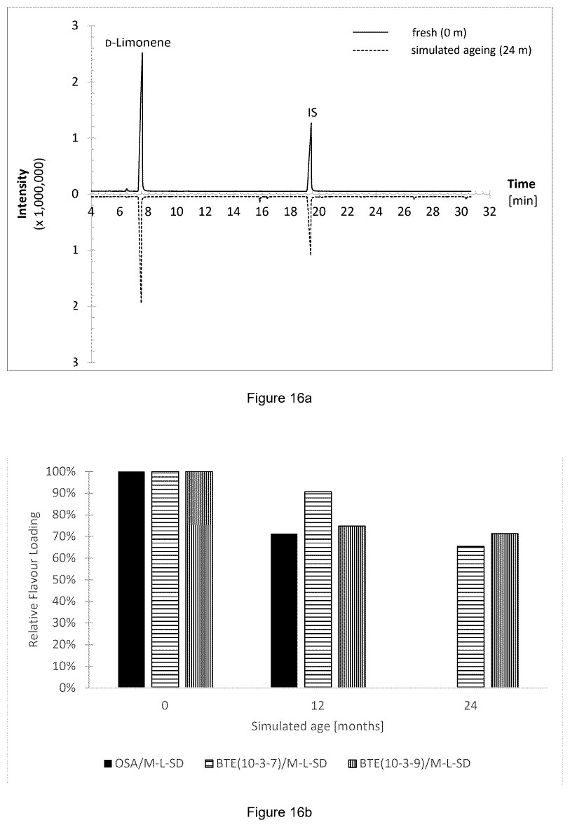

FIG. 16A Flavor analysis of D-limonene encapsulated by black tea cream/maltodextrin: Comparison of GC-FID chromatograms of fresh and aged powder (simulated shelf-life: 24 months) after solvent extraction. Formulation: BTE(10-3-7)/M-L-SD. Internal standard (IS): 2-nonanol.

FIG. 16B Measured limonene loadings during simulated ageing under variation of emulsifier/carrier systems: Comparison of tea cream/maltodextrin vs. OSA-modified starch/maltodextrin (=reference formulation). Relative limonene loading diagrammed (in relation to measured limonene loading without simulated ageing (0 months)). Flavor analyses by means of GC-MS/FID after addition of internal standard (2-nonanol) and solvent extraction. Simulated ageing of 24 months not tested for OSA/M-L-SD.

FIG. 16C Major identified degradation products from D-limonene encapsulating powders after 12 months of simulated ageing: Comparison of tea cream/maltodextrin vs. OSA-modified starch/maltodextrin (=reference formulation) as emulsifier/carrier systems. Flavor analyses by means of GC-MS/FID after addition of internal standard (2-nonanol) and solvent extraction.

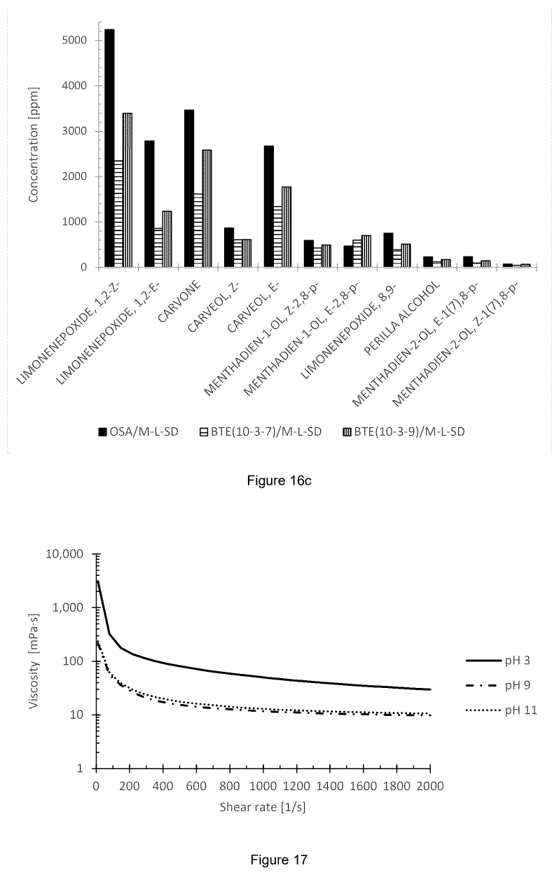

FIG. 17 Viscosity curves of tea cream upon titration with NaOH. Tea cream obtained after extraction (at pH 10 and 100 °C) and precipitation (at pH 3 and 4 °C). Y-axis (viscosity) in logarithmic scale.

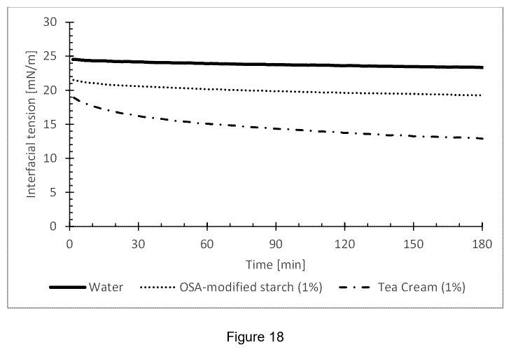

FIG. 18 Interfacial tension curves between oil and aqueous phases under variation of emulsifying agents: Comparison of OSA-modified starch and tea cream at respective concentration of 1% in water. Tea cream obtained after extraction at pH10, creaming at pH3, and resuspension by NaOH titration until pH9. “Water” as emulsifier-free reference.

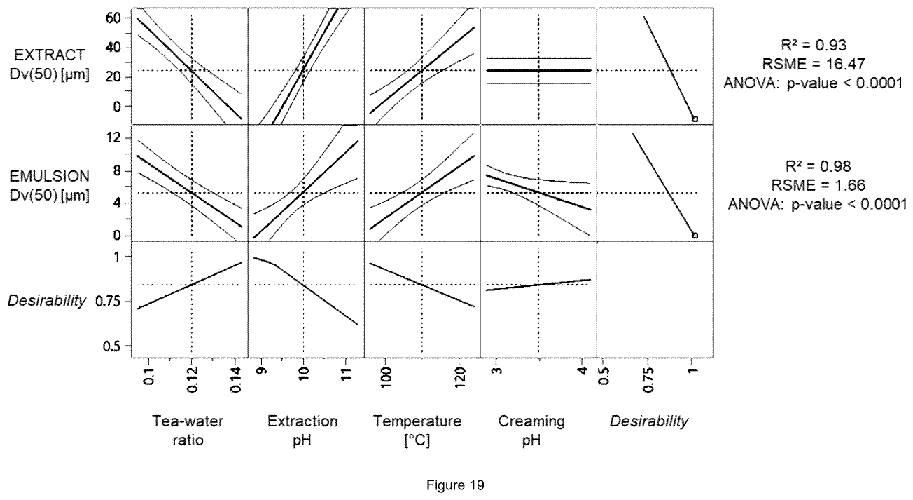

FIG. 19 Influence of mate leave extraction parameters on technofunctional properties Statistical evaluation of designed experiment: Visualization of modelled technofunctional properties (response variables) as functions of extraction parameters (experimental factors). Prediction profilers generated with JMP®. Solid lines: average responses. Shaded areas: confidence intervals (95% confidence level).

### EXAMPLES

### 1. Materials & Methods

### 1.1 Sample Preparation

As illustrated in FIG. 1 by way of examples, black tea leaves (BT), green tea leaves (GT) (both Camellia sinensis) or green mate leaves (Ma) (Ilex paraguariensis) (all: dry and loose) were extracted with water under variation of the following conditions: tea-water ratio (0.1-0.14), extraction time (30 min-120 min), extraction temperature (100 °C-120 °C). Extraction pH of the aqueous tea slurries (range: pH 3-12) were adjusted by either phosphoric acid (H₃PO₄) or caustic soda (NaOH) prior to extraction. After extraction, the still warm aqueous tea slurries (T>70 °C) were filtered with folded filter papers (MN 617 qualitative, MACHEREY-NAGEL, Düren, Germany) to remove the spent tea leaves. The permeates (“filtrated tea infusions”) were collected and the creaming pH levels were adjusted (test range: pH 3-9) by either H₃PO₄ or NaOH, while maintaining temperatures >45 °C. During the subsequent “creaming” phase, the initially dissolved solid components were precipitated at least 24 h. If not mentioned otherwise, the leaves were extracted at pH 10 with a tea-water ratio of 0.1 at 100 °C for 120 min, which was followed by a creaming at pH 3 (“standard conditions”).

After creaming, the extracts from black tea (BTE), green tea (GTE) or mate (MaE) were either intentionally phase-separated or used as such for further analytical and experimental purposes.

For the phase separation approach, the samples were centrifuged at 4 °C at 3000 g for 30 min. The liquid supernatant was removed by decanting. The dry matter content of the solid cream phase (i.e., precipitated colloidal particles) was gravimetrically determined by means of freeze drying. The cream yield was then calculated as cream mass (on dry-weight basis) in relation to filtrated tea infusion mass. The tea cream precipitates were resuspended either by solubilization in citrate-phosphate buffer solutions (Mcllvaine, 1921, A BUFFER SOLUTION FOR COLORIMETRIC COMPARISON. Journal of Biological Chemistry, 49, 183-186) or after direct titration of the cream with NaOH (test range: pH 3-11) in combination with high shearing.

For the alternative approach, the samples were optionally concentrated by water evaporation or boiling down. This was followed by an optional pH adjustment by titration with NaOH (test range: pH 3-9).

The concentrated suspensions of colloidal particles, obtained by one of the two approaches, were used for preparing emulsions. The mixtures were dispersed at maximum speed using a rotor-stator system (Ultra-Turrax, IKA, Germany), while the flavoring or plant oil (optionally pre-loaded with ester gum (wood rosin)) was added dropwise. The total disperging time was adjusted to the sample volume (e.g. 2 min for 60-150 mL; 6 min for 500-1000 mL). Optionally, maltodextrin as carrier for subsequent spray-drying, was added either before or after the emulsification step. The tested formulations for black tea are listed in Table. The extraction parameters for mate leaves were specifically investigated and statistically evaluated based on a custom design of experiments (DoE) using JMP® 16 (SAS Institute, Cary, North Carolina, USA) (Table 2).

The resulting homogenous emulsions were then used e.g. for analytical purposes, or subsequently spray-dried. Single-stage spray-drying of the emulsions was carried out using a centrifugal atomizer at an inlet air temperature of 190 °C and outlet air temperature of 70 °C. The tested formulations are listed in Table 3.

TABLE 1
Emulsion formulations using resuspended cream after extraction
of dry black tea leaves under standard conditions

| | | | | | | |
|---|---|---|---|---|---|---|
| BTE(3-3- | BTE(10- | BTE(10- | BTE(10- | BTE(10- | BTE(10- | BTE(10- |
| 8.5)- | 3-9)/M- | 3-9)-PO/ | 3-9)- | 3-9)- | 3-9)- | 3-9)- |
| PO-E | PO-E | EG-E | PO-E-1 | PO-E-2 | PO-E-3 | PO-E-4 |

Tea Cream Parameters:

| | | | | | | | |
|---|---|---|---|---|---|---|---|
| Extraction pH | 3 | 10 | 10 | 10 | 10 | 10 | 10 |
| Creaming pH | 3 | 3 | 3 | 3 | 3 | 3 | 3 |
| Resusp. pH | 8.5 ^{a} | 9 ^{b} | 9 ^{b} | 9 ^{b} | 9 ^{b} | 9 ^{b} | 9 ^{b} |

Formulation:

| | | | | | | | |
|---|---|---|---|---|---|---|---|
| Buffer pH 8.5 | 58.0 | | | | | | |
| Ester gum | | | 2.4 | | | | |
| d-Limonene | | | | | | | |
| Maltodextrin | | 44.5 | | | | | |
| Plant Oil | 8.0 | 8.0 | 5.6 | 8.0 | 20.0 | 40.0 | 60.0 |
| Resuspended | 5.5 | 45.0 | 45.0 | 108.0 | 80.0 | 80.0 | 80.0 |
| Tea Cream | | | | | | | |
| Water | | 58.0 | 58.0 | | | | |
| Total | 71.5 | 155.5 | 111.0 | 116.0 | 100.0 | 120.0 | 140.0 |
| Oil-Tea | 1.45 | 0.18 | 0.18 | 0.07 | 0.25 | 0.50 | 0.75 |
| cream-Ratio | | | | | | | |

| | BTE(10- | BTE(10- | BTE(10- | BTE(10- | BTE(10- |
|---|---|---|---|---|---|
| | 3-3)- | 3-5)- | 3-7)- | 3-9)- | 3-11)- |
| | L-E | L-E | L-E | L-E | L-E |
| Tea Cream Parameters: | | | | | |
| Extraction pH | 10 | 10 | 10 | 10 | 10 |
| Creaming pH | 3 | 3 | 3 | 3 | 3 |
| Resusp. pH | 3 ^{b} | 5 ^{b} | 7 ^{b} | 9 ^{b} | 11 ^{b} |
| Formulation: | | | | | |
| Buffer pH 8.5 | | | | | |
| Ester gum | | | | | |
| d-Limonene | 20.0 | 20.0 | 90.7 | 90.7 | 20.0 |
| Maltodextrin | | | | | |
| Plant Oil | | | | | |
| Resuspended | 80.0 | 80.0 | 362.6 | 362.6 | 80.0 |
| Tea Cream | | | | | |
| Water | | | | | |
| Total | 100.0 | 100.0 | 453.3 | 453.3 | 100.0 |
| Oil-Tea | 0.25 | 0.25 | 0.25 | 0.25 | 0.25 |
| cream-Ratio | | | | | |

^{a} Resuspension of precipitated cream in citrate-phosphate buffer (McIlvaine, 1921)
^{b} Resuspension of precipitated cream by NaOH titration

TABLE 2
Optimization of extraction of mate leaves towards technofunctionality.
Factor combinations applied in custom design of experiments.

| Experimental factors | min. | max. | Response variables | Desirability |
|---|---|---|---|---|
| Tea-water ratio | 0.1 | 0.14 | Extract particle size Dv(50) | minimal |
| Extraction pH | 9 | 11 | Emulsion droplet size | minimal |
| | | | Dv(50) | |
| Extraction temperature | 100 °C | 120 °C | | |
| Creaming pH | 3 | 4 | | |

TABLE 3
Emulsion formulations for subsequent spray drying.

| | BLACK TEA LEAVES | | MATE LEAVES | |
|---|---|---|---|---|
| | BTE(10-3- | BTE(10-3- | MaE(10-3-3)/M- | REFERENCE |
| Code | 7)/M-L-SD | 9)/M-L-SD | L-SD | OSA/M-L-SD |
| Process conditions: | | | | |
| Tea-water ratio | 0.1 | 0.1 | 0.14 | — |
| Extraction pH | 10 | 10 | 10 | — |
| Creaming pH | 3 | 3 | 3 | — |
| Resuspension pH | 7 ^{a} | 9 ^{a} | 3 ^{b} | |
| Formulation: | | | | |
| Concentrated suspension | 362.6 ^{c} | 362.6 ^{c} | 500 ^{d} | — |
| of colloidal particles | | | | |
| D-Limonene | 90.7 | 90.7 | 50 | 120.9 |
| Maltodextrin DE17-20 | 300.7 ^{e} | 300.7 ^{e} | 200 ^{f} | 327.5 |
| (Corn) | | | | |
| OSA-modified starch | — | — | — | 112.1 |
| Water | 246.0 | 246.0 | — | 559.4 |
| Total | 1,000.0 | 1,000.0 | 750 | 1,119.9 |

^{a} Resuspension of precipitated cream by NaOH titration
^{b} pH measured, but not further adjusted
^{c} Resuspended tea cream
^{d} without phase separation
^{e} Maltodextrin pre-solubilized in water. Solution added after emulsification
^{f} Maltodextrin directly added to emulsion after emulsification

### 1.2 Analyses of Colloidal Suspensions

Particle size distributions of the colloidal suspensions were measured with the laser diffraction analyzer Mastersizer 3000 (Malvern Instruments, Worcestershire, UK) equipped with a Hydro MV liquid dispersion unit. The following parameters were applied: Mie scattering; dispersant, water; stirring rate, 2400 rpm. The medians of the volume-weighted size distributions (Dv(50)) were calculated and used for comparative purposes.

Additionally, colloidal particles obtained from resuspended black tea cream in aqueous suspensions were analyzed at a concentration of 1% (1 g cream per 100 g deionized water/buffer). The particle size distributions were measured by means of dynamic light scattering (DLS) using a Microtrac NANO-flex (Microtrac BEL, Osaka, Japan), assuming transparent spherical particles.

Turbidity of the suspensions were measured using a 2100AN turbidimeter (Hach Lange, Berlin, Germany).

Zeta potentials of tea cream resuspended in deionized water (10 g/L) were determined by means of laser Doppler velocimetry using a Malvern Zetasizer Nano ZS90 (Malvern Instruments, Worcestershire, UK). HCl was used as a titrant.

Interfacial tensions of aqueous suspensions against plant oil were measured by means of Du-Nouy ring method using a K100 Force tensiometer (Krüss, Hamburg, Germany) equipped with a platinum ring (ring radius, 9.454 mm; wire diameter, 0.37 mm). 35 g aqueous suspension (1%, dry-weight based) was weighed into the measurement beaker and, after ring position adjustment to the interphase, covered with 35 g plant oil.

### 1.3 Analyses of Emulsions

Emulsion droplet size distributions and resulting Dv(50) medians were determined with the laser diffraction analyzer Mastersizer 3000 using the same parameters as mentioned above.

Viscosity measurements of the emulsions were performed with a MCR 302 rheometer (Anton Paar, Austria) using a cone-plate system at a ramped shear rate program (1-2000 m/s) and 25 °C in combination with the Rheoplus software (Anton Paar).

Microscopic images were obtained with the digital microscope VHX (Keyence, Osaka, Japan) equipped with an universal zoom lens VH-Z100UR (Keyence).

Zeta potentials of diluted emulsions (1:200 in deionized water) were determined using a Malvern Zetasizer Nano ZS90. HCl was used as a titrant.

### 1.4 Analyses of Powders

Powder droplet size distributions were determined with the laser diffraction analyzer Mastersizer 2000 (Malvern Instruments, Worcestershire, UK) equipped with a dry dispersion unit. The following parameters were applied: Fraunhofer model, 3 bar.

Flavor analyses of the powders were performed by solvent extraction followed by gas chromatography combined with mass spectrometry and flame ionization detection (GC-MS/FID). The overall flavor loading (after disruption of the microcapsules) and the surface oil of the powders were determined.

Accelerated shelf-life studies of the loaded powders were carried out using an Oxipres™ apparatus (Mikrolab, Aarhus, Denmark) to simulate storage of either 12 or 24 months. After incubation, the taste of the aged samples was compared to the non-aged samples by means of sensory triangular tests.

### 2. Results

At first, a process was developed to optimize tea cream yield, whereof variation of pH played a major role. The highest tea cream yield was obtained after alkaline tea extraction (preferably pH10) in combination with subsequent acidic creaming precipitation (preferably pH3) (see FIG. 2). The solid precipitates could then be easily separated from liquid supernatants.

### 2.1 Identification of Colloidal Particles

Leaves from mate, green tea, and black tea were extracted according to the developed process flow and the formation of CTPs was compared (Table 4). Following identical extraction and creaming conditions, increasing the pH from acidic (pH 3) to neutral (pH 7) significantly lowered the colloidal particle sizes. Surprisingly, the CTP structures strongly varied between the botanical raw materials. After acidic creaming, colloidal particle size in mate extracts were substantially smaller than in the green and black tea counterparts. Related to this, the visible phase separation after acidic creaming was significantly slower for MaE. The MaE(10-3-3) suspension was still homogenously opaque after several days. By contrast, a solid precipitate and an almost clear supernatant have formed during creaming for GTE (10-3-3). Interestingly, a gel network (with hardly any syneresis) has developed for BTE(10-3-3), which spanned over the entire filtrated tea infusion. This indicated the high tendency of cream formation in BTEs.

TABLE 4
Medians (Dv(50)) of colloidal particles from extracted botanical leaves.
Aqueous extracts obtained under standard conditions, followed by pH adjustment
to different pH levels. Measured by means of Malvern 3000.

| | | | | Particle Size Dv(50) | | |
|---|---|---|---|---|---|---|
| | pH Adjustment | | | [μm] | | |
| | | | Resuspension/ | Mate Extract | Green Tea | Black Tea |
| Codes | Extraction | Creaming | Modification | (MaE) | Extract (GTE) | Extract (BTE) |
| (10-3-3) | pH 10 | pH 3 | pH 3 | 0.52 ± 0.00 | 9.89 ± 0.28 | 70.90 ± 3.17 |
| (10-3-5) | pH 10 | pH 3 | pH 5 | 0.48 ± 0.02 | 10.70 ± 0.24 | 14.70 ± 0.19 |
| (10-3-7) | pH 10 | pH 3 | pH 7 | 0.05 ± 0.00 | 0.09 ± 0.04 | 0.06 ± 0.00 |

### 2.2 Formation of Tea Cream

The underlying formation mechanisms of tea cream and related CTPs were further investigated for BTEs. As shown in FIG. 2, pH adjustment before or after extraction significantly influenced the quantity of formed cream. Overall, more tea cream formed at higher extraction pH levels, which was explained by superior extraction efficiency of solid compounds under alkaline conditions. An even more significant effect on tea cream formation was caused by adjusting the pH prior to “creaming” precipitation (and thus after extraction). Lowering the creaming pH considerably increased the cream yield further. The highest tea cream yield was obtained upon aqueous tea extraction under alkaline conditions (preferably pH>9) in combination with subsequent creaming precipitation under acidic conditions (preferably pH3) (see FIG. 2). For this combination, a solid gel network formed after the developed “creaming” precipitation conditions from the initially liquid filtrated tea infusion. This was explained, by maximizing extraction yields of tea solids due to alkaline conditions and subsequent maximizing precipitation previously solubilized compounds of due to acidic conditions.

By comparing FIGS. 2 and 3, the quantities of tea cream correlated well with the respective measured diameters of the present colloidal particles. Larger colloidal particle sizes thus resulted in a higher tendency towards cream precipitation.

### 2.3 Resuspension Optimization

In the next step, a crucial hurdle was the resuspension of the solid precipitated tea cream into dispersion, as this was the prerequisite for subsequent oil/flavor incorporation. It was demonstrated that solid tea cream can be efficiently resuspended by means of shearing and pH increase. Above pH 7, tea cream significantly liquefied and the initial gel network was disrupted, which was crucial for further handling. With increasing pH, the sizes of the suspended colloidal particles derived from tea cream became smaller, eventually below 200 nm for pH>7 (see FIGS. 6 & 7). Simultaneously, the turbidity of the resuspended tea cream strongly declined with increasing pH.

As shown in FIG. 17, viscosity measurements of the obtained tea creams revealed their strong shear-thinning behaviour. Before shearing, a strong initial gel network has been maintained with an apparent yield stress. Upon shearing, the viscosity plummeted with increasing shear rate. For instance, the viscosity of tea cream at pH 3 dropped below 100 mPas for shear rates larger than 400 1/s. The viscosity of tea cream was furthermore highly pH-dependent. With increasing pH upon titration with NaOH, the viscosity decreased significantly until pH 9. Further addition of NaOH to even higher pH (e.g., pH 11) did not further decrease the viscosity. Next to the smaller colloidal particle sizes, a second benefit of increasing the pH of the tea cream was therefore the optimization of the further technical handling due to lower viscosities.

The results of optimizing resuspension of the tea cream are summarized in Tables 5 to 7. FIG. 4 shows the stability of tea cream resuspended in phosphate-citrate-buffers directly after stirring (FIG. 4a) and after 24 h sedimentation time (FIG. 4b). Interestingly, the choice of the buffering system strongly impacted the resuspension process. Preferably, direct titration with NaOH of the cream was applied, as it resulted in smaller colloidal particles, lower turbidity, and less visible aggregates (compared to cream resuspension in citrate-phosphate-buffers) (see Tables 5 to 7 and FIGS. 3 to 6).

TABLE 5
Turbidity of tea cream resuspended in phosphate-citrate-buffer. Tea
cream obtained after extraction under standard conditions. Suspension
measured at concentration of 1 g cream per 100 g of buffer.

| Buffer pH | 2 | 5 | 7 | 8.5 |
|---|---|---|---|---|
| FNU | 158 | 50.7 | 14.2 | 7.8 |
| FAU | 305 | 129 | 78.7 | 94.7 |
| NTU | 165 | 55.3 | 16.1 | 9.4 |
| Visual | No complete | Almost complete | Almost complete | Almost complete |
| appearance | solubilization, high | solubilization, | solubilization, low | solubilization, low |
| | turbidity, strong | medium turbidity, | turbidity, slight | turbidity with visual |
| | sedimentation after | slight sedimentation | sedimentation after | hazing particles, |
| | 2 d | after 2 d | 2 d | slight sedimentation |
| | | | | after 2 d |

TABLE 6
Turbidity of tea cream resuspended in deionized water upon titration with
NaOH. Tea cream obtained after extraction under standard conditions.
Suspension measured at concentration of 1 g cream per 100 g of buffer.

| Titration pH | 3 | 5 | 7 | 9 | 11 |
|---|---|---|---|---|---|
| FNU | 125 | 52.8 | 1.18 | 0.95 | 0.66 |
| FAU | 288 | 123 | 45.3 | 77.2 | 66.9 |
| NTU | 136 | 58.3 | 1.3 | 1.14 | 0.77 |
| Visual | No complete | No complete | Complete | Complete | Complete |
| appearance | solubilization, | solubilization, | solubilization, | solubilization, | solubilization, |
| | high turbidity, | high turbidity, | no turbidity, no | no turbidity, no | no turbidity, no |
| | strong | strong | sedimentation | sedimentation | sedimentation |
| | sedimentation | sedimentation | after 2 d | after 2 d | after 2 d |
| | after 2 d | after 2 d | | | |

TABLE 7
Turbidity of tea cream resuspended in deionized water upon titration with NaOH.
Tea cream obtained after extraction (at pH 10 and 100 °C) and precipitation
(at pH 5 and 4 °C). Suspension measured at concentration of 1 g cream per
100 g of buffer using a 2100AN turbidimeter (Hach Lange GmbH, Berlin, Germany).

| Titration pH | 5 (n.a.) | 7.0 | 9.0 | 11.0 |
|---|---|---|---|---|
| FNU | 41.6 | 2.6 | 1.0 | 0.9 |
| FAU | 118.0 | 43.5 | 97.2 | 131.0 |
| NTU | 45.6 | 2.8 | 1.4 | 1.2 |
| Visual | No complete | Complete | Complete | Complete |
| appearance | solubilization, high | solubilization, no | solubilization, no | solubilization, no |
| | turbidity, strong | turbidity, no | turbidity, no | turbidity, no |
| | sedimentation after | sedimentation after | sedimentation after | sedimentation after |
| | 2 d | 2d | 2 d | 2 d |

FIG. 5 shows the stability of tea cream resuspended in deionized water upon titration with NaOH after 2 d sedimentation time. FIG. 6 illustrates the particle size distributions of tea cream resuspended in phosphate-citrate-buffers (Mcllvaine, 1921). FIG. 7 shows the particle size distributions of tea cream resuspended in deionized water upon titration with NaOH.

Zeta-potential is a measure for electrostatic repulsion between colloidal particles. Zeta potentials <−30 mV were measured for the resuspended colloidal particles from tea cream under alkaline conditions (FIG. 8). Zeta-potential magnitudes in this range typically indicate colloidal stability, as high electrostatic repulsion between particles prevents their aggregation or coagulation (Lin, P.-C., Lin, S., Wang, P. C., & Sridhar, R. (2014). Techniques for physicochemical characterization of nanomaterials. Biotechnology advances, 32, 711-726). Upon acidification, the measured zeta potential magnitudes of the tea cream suspension declined, which made aggregation towards larger particles more likely. This was in accordance with the measured colloidal particle sizes (FIGS. 6 and 7).

Overall, the results indicated that the precipitation and resuspension of colloidal tea particles was seemingly reversible and thus applicable for technological purposes.

### 2.4 Emulsification Optimization

The aqueous extracts generated according to the developed process from dry leaves of mate, green tea, or black tea were successfully applied as emulsifying systems. This demonstrated the technofunctional capabilities of the CTPs to form and stabilize emulsion droplets. After emulsification of plant oil pre-loaded with ester gum (PO/EG), the formed emulsion droplet size distributions varied significantly between the botanical raw materials and the adjusted PH levels (Table 8). The comparison of Tables 4 & 8 illustrates the key role of colloidal particle structure on the following emulsification process, as smaller extract particle sizes also coincided with smaller emulsion droplet sizes.

TABLE 8
Medians (Dv(50)) of emulsions droplets stabilized by colloidal particles from
extracted botanical leaves. Continuous phases (108 g): aqueous extracts containing
colloidal particles, generated under standard conditions, adjusted to different
pH levels. Dispersed phases (8 g): Plant oil loaded with ester gum (PO/EG).
Extract codes according to Table 4. Measured by means of Malvern 3000.

| Codes | Emulsion | Sampling | Mate | Green Tea | Black Tea |
|---|---|---|---|---|---|
| (Extract) | pH | time | (MaE-PO/EG-E) | (GTE-PO/EG-E) | (BTE-PO/EG-E) |
| (10-3-3) | pH 3 | fresh | 1.83 ± 0.01 | 2.90 ± 0.06 | 13.30 ± 0.65 |
| | | stored | 2.00 ± 0.01^{a} | 4.46 ± 0.12^{a} | 20.70 ± 0.99^{b} |
| (10-3-7) | pH 7 | fresh | 3.36 ± 0.01 | 6.19 ± 0.06 | 2.58 ± 0.01 |
| | | stored | 2.15 ± 0.01^{b} | 5.96 ± 0.04^{a} | 4.77 ± 0.09^{b} |

^{a}remeasured after 24 h
^{b}remeasured after 28 d

Emulsifying agents necessarily lower the interfacial tension between immiscible oil and aqueous phases upon adsorption to the interface. Lower interfacial tensions facilitate the droplet breakup into smaller droplets, which is thus a crucial prerequisite for the formation of stable emulsions. A comparison between the interfacial tension curves demonstrated that colloidal particles from tea cream reduced the interfacial tension significantly stronger than the conventionally used OSA-modified starch at identical concentrations (FIG. 18). This illustrated the good interfacial activity of the tea cream.

The resuspended tea cream particles were successfully applied for formation and stabilization of oil-in-water emulsions with droplet sizes <10 μm (see FIG. 9). Microscopic images confirmed the measured emulsion droplet sizes. Zeta-potentials measurements of the tea cream-based emulsions demonstrated the negative charges of the droplets and their high electrostatic repulsion over a broad span of pH levels (see FIG. 8).

The stabilities of different formulations were compared, whereof further technofunctional agents were optionally added to counteract buoyancy of the lighter dispersed emulsion phase. In order to limit upward migration of oil droplets according to Stoke's law, either the viscosity of the continuous phase was increased (e.g., by maltodextrin) or the density difference between the phases was decreased (e.g., by ester gum). FIG. 9 shows the oil droplet stability of plant oil emulsions stabilized by colloidal particles obtained from tea cream. Over the course of at least 7 days, the emulsion droplet size distributions have not changed significantly, which indicated that coalescence or Ostwald ripening had not been occurring (see FIG. 9).

A microscopic image of plant oil emulsion stabilized colloidal particles obtained from black tea cream can be seen in FIG. 10. FIG. 11 shows the corresponding Zeta-potential measurements. The measured droplet size distributions resulting from emulsification of plant oil by black tea cream under variation of oil-cream-ratio are shown in FIG. 12. Increasing the oil loading of the tea cream-based emulsions resulted in larger droplet sizes, which indicated the optimal range of oil-tea cream ratios (see FIG. 12).

As mentioned above, higher pH levels for tea cream resuspension resulted in smaller colloidal particle sizes (see FIGS. 6 & 7). FIG. 13 shows the results of emulsification of D-limonene by black tea cream at different resuspension pH values on the basis of oil droplet size distributions. As can be seen, higher cream titration pH levels also resulted in smaller emulsion droplet sizes (see FIG. 13). From that, it was concluded that smaller colloidal sizes were preferable for subsequent oil/flavor emulsification, as they resulted in smaller emulsion droplet sizes. Smaller droplet sizes are furthermore generally preferably for emulsion stability, as larger droplets are more prone to coalescence and/or upward migration processes due to buoyancy force. Overall, the results confirmed the hypothesis that tea cream colloidal particles act as Pickering emulsifying agents, by adsorption to the droplet interface and by prevention of droplet coalescence.

As also mentioned above, CTPs formed from mate leaves were substantially smaller at acidic conditions, which was considered a surprising effect (see Table 4). Equally, the formation and stability of the MaE-based emulsions were superior in comparison to BTE and GTE at low PH levels (see Table 8). As many beverages are acidic (typical range: pH 2 to pH 5), mate-based colloidal particles may represent an interesting technofunctional option. Against this background, the formation of colloidal particles from mate was specifically optimized towards subsequent emulsification purposes using a custom DoE approach. This allowed investigating statistical correlations between controlled extraction factors and resulting emulsification behavior (response variables) as well as interactions between the factors. An illustration of the generated statistical model with representative experimental factor combinations is shown in FIG. 19. As a surprising and desirable effect, higher tea-water ratios and thus more concentrated aqueous extracts resulted in significantly smaller CTP sizes and thus also smaller emulsion droplet sizes.

### 2.5 Drying Optimization

In upscaling trials, flavor emulsions stabilized by concentrated suspensions of colloidal particles obtained from the developed process were subsequently spray dried. The versions “BTE(10-3-7)/M-L-SD” and “BTE(10-3-9)/M-L-SD” contained resuspended black tea creams as emulsifying agents. For version “MaE(10-3-3)/M-L-SD”, a concentrated mate extract containing CTPs was used. Maltodextrin was used as additional carrier material in order to adjust the solid content and the viscosity of the emulsions for optimal spray drying conditions. This allowed microencapsulation of D-limonene (as representative non-polar flavoring) by colloidal tea particles. The developed process resulted in homogeneous dry powders with desirable particle sizes <65 μm and low moisture contents. Also in this case, smaller colloidal cream particles as a result of higher titration pH levels significantly correlated with smaller emulsion droplet diameters and also smaller powder particle diameters (see FIG. 14 and Table 9, compare with FIG. 7).

When the limonene-encapsulating powders were resolubilized in water, the flavoring droplets remained stabilized by the colloidal particles. For instance, the measured droplet size median of the mate-based powder (MaE(10-3-3)/M-L-SD) in water (0.5 g/L) remained at a comparable low level (Dv (50)=2.69 μm). These application tests demonstrated that the colloidal tea particle-based encapsulation procedure had endured the spray-drying process.

TABLE 9
Encapsulation of D-limonene by means of spray drying using tea cream and maltodextrin
as emulsifier/carrier system: Physical characterization of emulsions and powders under
variation of resuspension pH of tea cream. Formulations according to Table 3.

| | | Emulsion | | Powder | | | | |
|---|---|---|---|---|---|---|---|---|
| | | Titration | | | | | | |
| | | D_{4, 3} | D(50) | Dry | D_{4, 3} | D(50) | Flavour | Surface |
| Resuspended Tea Cream | | [μm] | [μm] | matter | [μm] | [μm] | Loading | Oil |
| BTE(10-3-7)/M-L-SD | pH 7 | 4.54 ± 0.36 | 3.86 ± 0.25 | 95.40% | 21.71 ± 0.06 | 21.05 ± 0.06 | 15.62% | 0.37% |
| BTE(10-3-9)/M-L-SD | pH 9 | 3.57 ± 0.1 | 3.18 ± 0.06 | 94.30% | 21.02 ± 0.10 | 20.37 ± 0.10 | 14.65% | 0.96% |
| MaE(10-3-3)/M-L-SD | pH 3 | 2.93 ± 0.09 | 1.69 ± 0.00 | 97.50% | 13.80 ± 0.29 | 13.06 ± 0.08 | 15.53% | 0.07% |

Limonene is highly susceptible towards deterioration due to oxidative reactions and was thus chosen as a non-polar model flavoring for encapsulation experiments.

After microencapsulation by means of spray drying, the limonene-containing powders were aged in simulated shelf-life tests using an Oxipres™ apparatus. This was compared for the tea cream/maltodextrin combinations and a reference formulation with the same D-limonene loading using OSA-modified starch as emulsifier (instead of resuspended tea cream). The pressure curves were monitored during the simulated ageing. Pressure decline throughout the process is a general indicator for oxygen consumption and thus also for occurring oxidation reactions. FIG. 15 shows pressure curves during simulated ageing (12 months). It can be seen that the pressure decrease and thus oxidative reactions were significantly lower for tea cream combinations compared to the reference formulation.

Sensory triangle tests were administered in order to discriminate organoleptic changes between the fresh and simulated-ageing powders (0.2 g/L on test solution). For the mate-based powder (MaE(10-3-3)/M-L-SD), only 5 out of 10 trained panelists identified the correct answer. At a significance level of 95%, it consequently failed to reject the null hypothesis, so that no significant sensory differences were detectable throughout the simulated powder ageing.

The fresh and simulated-ageing powders were also analyzed by means of GC-MS/FID (FIG. 16A). The comparison of the chromatograms of both powders were highly comparable regarding the quantities of d-limonene and the formation of oxidative degradation products of limonene was limited. Less amounts of D-limonene degradation products were measured in CTP-based powders compared to the OSA-modified starch-based reference formulation. This illustrated the retention throughout the simulated ageing and thus oxidative stability due to colloidal tea particles.

Flavor analyses of d-limonene encapsulated by different emulsifier/carrier combinations are shown in FIGS. 16A-C. After 12 months of simulated ageing by means of Oxipres™, the loadings of the target analyte limonene decreased significantly more for the OSA-modified starch-based powder (OSA/M-L-SD) compared to CTP-based powders (BTE(10-3-7)/M-L-SD & BTE(10-3-9)/M-L-SD) (FIG. 16B). Simultaneously, the amounts of detected degradation products from D-limonene with typical off-flavor notes were higher for the OSA-modified starch-based powder compared to CTP-based powders (FIG. 16C). The flavor analyses therefore further demonstrated the enhanced antioxidative stability of flavor encapsulation by means of colloidal particles from tea cream.

Simulated ageing by means of Oxipres™ of limonene-encapsulating powders demonstrated the chemical stability of the powders against oxidative deterioration. The antioxidative potential of the flavor stabilization by colloidal tea particles was related to the presence of polyphenols (directly located at the flavor droplet interfaces).

1. A process for resuspending precipitated colloidal particles from a botanical raw material comprising:
(a) providing the precipitated colloidal particles;
(b) resuspending the colloidal particles in water with an alkali base, optionally in combination with shearing; and
(c) obtaining a liquified suspension comprising suspended colloidal particles derived from the botanical raw material.

2. The process of claim 1, wherein the precipitated colloidal particles comprise polyphenols and optionally, compounds from one, two, or three compound classes selected from proteins, polysaccharides, and methylxanthines.

3. The process of claim 1, wherein the colloidal particles are resuspended at a pH value of 2 to 12.

4. The process of claim 1, wherein the botanical raw material includes tea leaves from varieties of Camellia sinensis or Ilex paraguariensis.

5. The process of claim 1, wherein the suspended colloidal particles have a volume median particle size of 1000 nm or lower.

6. A process for producing precipitated colloidal particles from a botanical raw material comprising:
(I) conducting alkaline extraction of the botanical raw material to form an extract;
(II) conducting acidic creaming precipitation of the extract to form colloidal particles; and
(III) concentrating the colloidal particles.

7. The process of claim 6, wherein the alkaline extraction of the botanical raw material comprises:
(I-a) providing the botanical raw material;
(I-b) adding water to the botanical raw material and adjusting the pH value to more than pH 7;
(I-c) incubating the pH-adjusted mixture of the water and the botanical raw material and, optionally, maintaining the mixture at a temperature above ambient temperature; and
(I-d) after the incubating, separating liquid from solid to provide the extract.

8. The process of claim 6, wherein the acidic creaming precipitation of the extract to form the colloidal particles comprises:
(II-a) adjusting the pH value of the extract to less than pH 7; and
(II-b) incubating the pH-adjusted extract under conditions suitable for precipitation to precipitate the colloidal particles.

9. The process of claim 6, wherein the alkaline extraction comprises one or more of:
adding water in a weight excess relative to the weight of the botanical raw material;
incubating the pH-adjusted mixture of the water and the botanical raw material at a temperature above 50 °C;
incubating the pH-adjusted mixture of the water and the botanical raw material for at least 30 minutes;
ensuring the temperature of the incubated mixture of the water and the botanical raw material, when subjected to the separation, is at least 30 °C;
and/or wherein the acidic creaming precipitation comprises one or more of:
inclubating the pH-adjusted extract at sub-ambient temperature;
maintaining the incubation temperature for at least 6 hours;
separating the precipitated colloidal particles from the supernatant by filtration, centrifugation, decanting, and/or evaporation.

10. The process of claim 6, further comprising
(IV) resuspending the concentrated colloidal particles in water with an alkali base, optionally in combination with shearing; and
(V) obtaining a liquified suspension comprising suspended colloidal particles derived from the botanical raw material.

11. A process for producing a dispersion with technofunctional properties comprising:
(i) providing a liquified suspension comprising suspended colloidal particles from a botanical raw material;
(ii) adding a functional agent to the suspension;
(iii) preparing an emulsion comprising the functional agent;
(iv) optionally, drying the emulsion; and
(v) providing the dispersion with technofunctional properties in the form of the emulsion or the dried emulsion.

12. Colloidal particles from a botanical raw material produced or producible by the process of claim 6, wherein the colloidal particles comprise polyphenols and optionally, compounds from one, two, or three compound classes selected from proteins, polysaccharides, and methylxanthines.

13. (canceled)

14. A liquified suspension comprising suspended colloidal particles derived from a botanical raw material produced or producible by the process of claim 1, wherein the liquified suspension comprises polyphenols and optionally, compounds from one, two, or three compound classes selected from proteins, polysaccharides, and methylxanthines.

15. A preparation comprising polyphenols produced or producible by the process of claim 11, the comprising.

16. The process of claim 1, wherein the liquefied suspension comprises polyphenols and optionally, compounds from one, two, or three compound classes selected from proteins, polysaccharides, and methylxanthines.

17. The process of claim 1 wherein the colloidal particles are resuspended at a shear rate of at least 200 s⁻¹.

18. The process of claim 1, wherein the botanical raw material is tea leaves.

19. The process of claim 2, wherein the polyphenols are oxidized polyphenols.

20. The process of claim 1, wherein the colloidal particles are resuspended at a shear rate of at least 200 s⁻¹.
